(19) United States
(12) Patent Application Publication
(10) Pub. No.: US 2010/0221446 A1
(43) Pub. Date: Sep. 2, 2010

(54) APPARATUS AND METHOD FOR COLORING RECOGNIZABLE TOOL BIT

(76) Inventor: Shao-Hsien HSU, Dali City (TW)

Correspondence Address: Yen Jung Sung, 21-80 38 St, #C8, Astoria, NY, 11105, US

(21) Appl. No.: 12/395,680

(22) Filed: Mar. 1, 2009

(51) Int. Cl. B05D 1/28; B05C 1/02

(52) U.S. Cl. 427/429; 118/232

(57) ABSTRACT

An apparatus for coloring a recognizable tool bit includes an operating system and a control system electrically connected to the operating system. The operating system has a rotating mechanism having a rotor extending therefrom for adapting to connect to a tool bit. A supplying mechanism is provided for adapting to store dyestuffs and inject the dyestuffs for coloring the tool bit. A daubing mechanism is relatively connected to the supplying mechanism for soaking dyestuffs from the supplying mechanism and daubing the dyestuff on the tool bit.

### BACKGROUND OF THE INVENTION

1. Field of the Invention

The present invention relates to a tool bit, and more particularly to an apparatus and a method for coloring a recognizable tool bit.

2. Description of Related Art

A conventional recognizable tool bit includes a tool bit. The tool bit has a head, a neck connected to the head, and an inserter connected to the neck. An aluminum-alloy recognizable ring is sleeved on the neck. The recognizable ring has an outer periphery protruding from the neck. A color of the recognizable ring is provided for recognizing a standard of the tool bit.

The conventional recognizable tool bit provides a recognizable effect for a user to easily recognize the standard of the tool bit during operation. However, it is inconvenient to sleeve the recognizable ring on the neck of the tool bit. Furthermore, the aluminum-alloy recognizable ring increase the production cost.

The present invention has arisen to mitigate and/or obviate the disadvantages of the conventional recognizable tool bit.

### SUMMARY OF THE INVENTION

The main objective of the present invention is to provide an improved method and apparatus for coloring a recognizable tool bit.

To achieve the objective, the method for coloring a recognizable tool bit in accordance with the present invention comprises: Positioning step: a tool bit is positioned on a rotating mechanism. Setting step: a pressure of a supplying mechanism is set to adjust a flow rate of the supplying mechanism for deciding a thickness of a color layer of the tool bit. Daubing step: the daubing means is contacted with the tool bit. The rotating mechanism rotates the tool bit for annularly coloring on an outer periphery of the tool bit. Removing step: the colored tool bit is detached from the rotating mechanism.

The apparatus for coloring a recognizable tool bit in accordance with the present invention comprises an operating system and a control system electrically connected to the operating system. The operating system has a rotating mechanism having a rotor extending therefrom for adapting to connect to a tool bit. A moving mechanism is movable relative to the rotating mechanism and selectively contacted with the rotating mechanism. The moving mechanism has a supplying mechanism provided for adapting to store dyestuffs and inject the dyestuffs for coloring the tool bit. The moving mechanism has a daubing mechanism relatively connected to the supplying mechanism. The daubing mechanism has a brush mounted thereon. The brush is contacted with the supplying mechanism for soaking dyestuffs from the supplying mechanism and daubing the dyestuff on the tool bit. The control system has a switch provided for switching on the operating system;

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for coloring a recognizable tool bit in accordance with the present invention;

FIG. 2 is a perspective view of an apparatus for coloring a recognizable tool bit in accordance with the present invention;

FIG. 3 is a side plane view of the apparatus for coloring a recognizable tool bit in accordance with the present invention;

FIG. 4 is an operational view of the apparatus for coloring a recognizable tool bit in accordance with the present invention;

FIG. 5 is a partial enlarged pane view of a brush and the rotor in FIG. 4; and

FIG. 6 is a perspective view of a recognizable tool bit colored by the apparatus in accordance with the present invention.

### DETAILED DESCRIPTION OF THE INVENTION

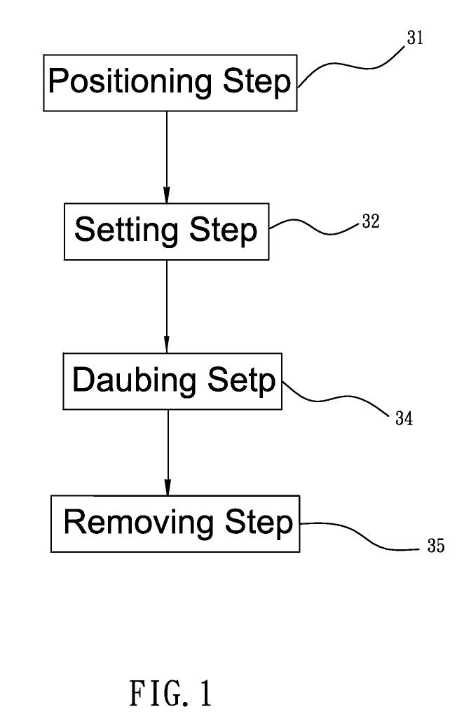

Referring to the drawings and initially to FIG. 1, a method for coloring a recognizable tool bit in accordance with the present invention comprises positioning step (31), setting step (32), daubing step (34), and removing step (35). Positioning step (31): a tool bit is positioned on a rotating mechanism (21). Setting step (32): a pressure of a supplying mechanism (222) is set to adjust a flow rate of the supplying mechanism (222) for deciding a thickness of a color layer of the tool bit. A contacting time is set whereof the daubing mechanism (221) is contacted with the tool bit for adjusting the thickness of the colored layer of the tool bit. A rotating time is set whereof the rotating mechanism (21) rotates the tool bit for adjusting the thickness of the colored layer of the tool bit. Daubing step (34): the daubing means is contacted with the tool bit. The rotating mechanism (21) rotates the tool bit for annularly coloring on an outer periphery of the tool bit. Removing step (35): the colored tool bit is detached from the rotating mechanism (21).

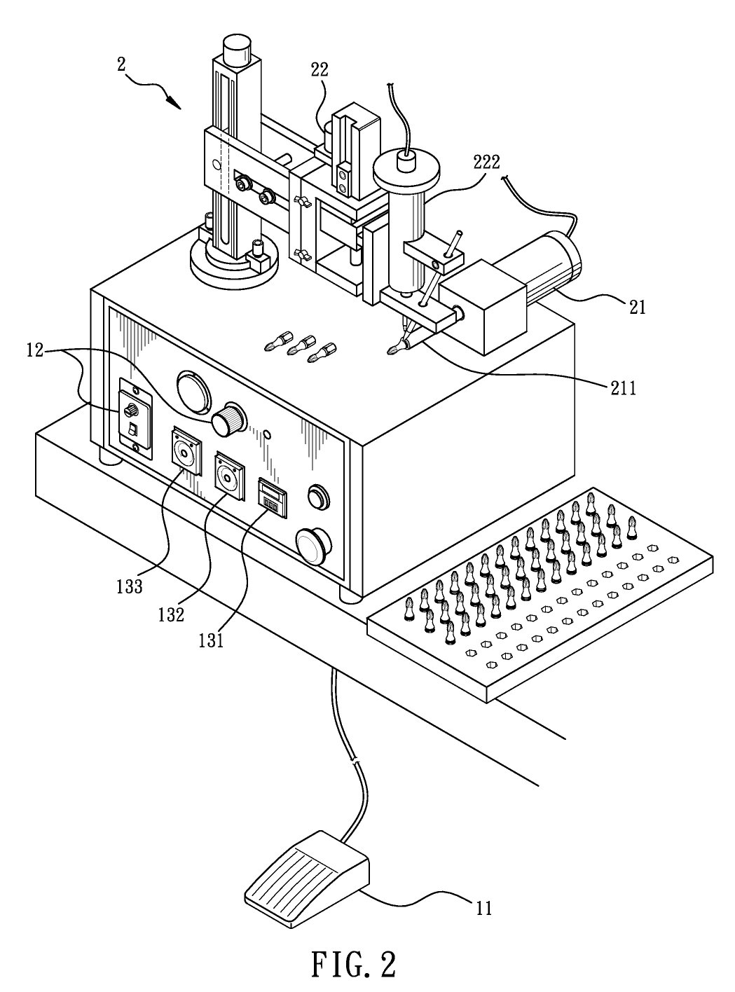

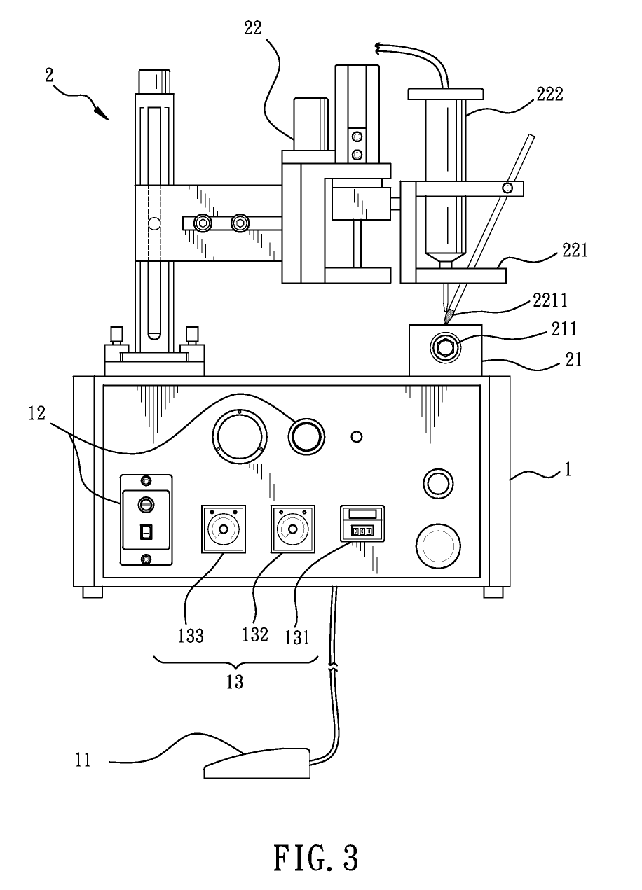

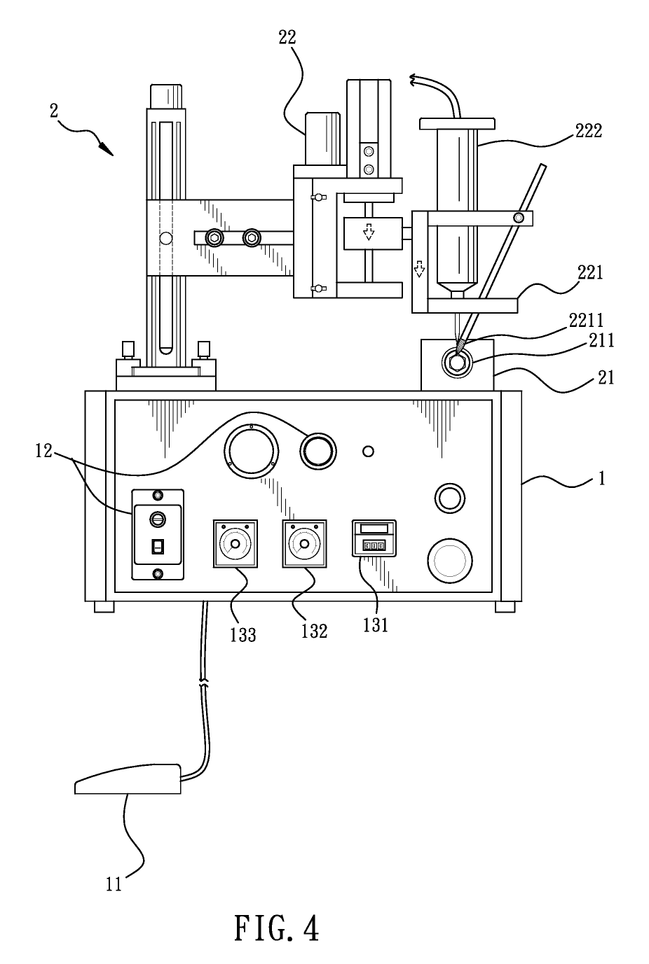

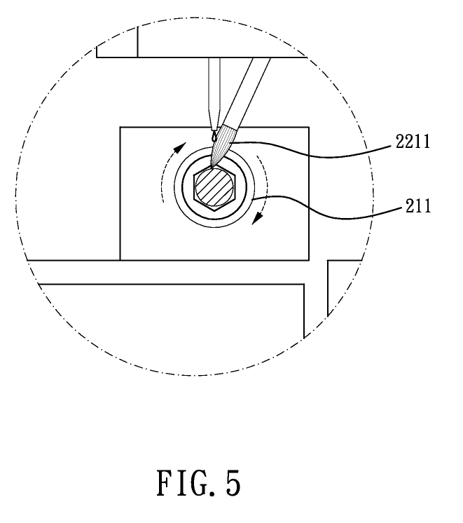

Referring to the drawings and initially to FIGS. 2-6, an apparatus for coloring a recognizable tool bit in accordance with the present invention comprises a control system (1) and an operating system (2) electrically connected to the control system (1).

The operating system (2) includes a rotating mechanism (21) and a moving mechanism (22) mounted adjacent to the rotating mechanism (21). The moving mechanism (22) is movable relative to the rotating mechanism (21) and is selectively contacted with the rotating mechanism (21). The rotating mechanism (21) has a rotor (211) extending therefrom for adapting to connect to a tool bit. The moving mechanism (22) has a supplying mechanism (222) provided for storing dyestuffs (not shown) and injecting the dyestuffs for coloring the tool bit on the rotor (211). The supplying mechanism (222) is a high pressure supplying mechanism. The moving mechanism (22) has a daubing mechanism (221) relatively connected thereto and being adjacent to the supplying mechanism (222). The daubing mechanism (221) has a brush mounted thereon. The brush is selectively contacted with the supplying mechanism (222) for soaking dyestuffs from the supplying mechanism (222) and daubing the dyestuff on the tool bit.

The control system (1) drives the operating system (2). The operating system (2) is mounted on the control system (1). The control system (1) has a pedal-typed switch (11) provided for switching on/off the operating system (2). The control system (1) has a display module (13) mounted thereon. The display module (13) including a supplying counter (131) provided for showing an injecting time of the supplying mechanism (222), a contacting counter (132) provided for showing a contacting time whereof the brush contacted with the tool bit, and a rotating counter (133) provided for showing a rotating time of the rotor (211). The control system (1) has a button assembly (12) mounted thereon and provided for adjusting a flow rate of the dyestuffs supplied by the supplying mechanism (222), adjusting a contacting time whereof the brush contacted with the tool bit, and adjusting a number of cycles of the rotor (211).

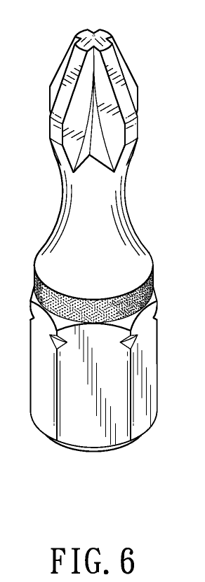

When operating, the tool bit is positioned on the rotor (211). The button assembly (12) is set for adjusting the flow rate of the dyestuffs, the contacting time, the number of cycles of the rotor (211). The display module (13) is provided for correcting the settings of the flow rate, the contacting time, and the number of cycles. The switch (11) of the control system (1) is switched on. The rotor (211) of the rotating mechanism (21) rotates the tool bit. The moving mechanism (22) drives the supplying mechanism (222) and the daubing mechanism (221) to contact with tool. The supplying mechanism (222) injects the dyestuffs on the brush. The brush of the daubing mechanism (221) is contacted with the too bit for coloring the tool bit to be a recognizable tool bit, as shown on FIG. 6.

Although the invention has been explained in relation to its preferred embodiment, it is to be understood that many other possible modifications and variations can be made without departing from the spirit and scope of the invention as hereinafter claimed.

What is claimed is:

1. A method for coloring a recognizable tool bit comprising:
positioning step: a tool bit positioned on a rotating means;
setting step: adjusting a pressure of a supplying means to adjust a flow rate of a daubing means for deciding a thickness of a colored layer of the tool bit;
daubing step: the daubing means contacted with the tool bit, the rotating mechanism rotating the tool bit for annularly coloring on an outer periphery of the tool bit; and
removing step: detaching the colored tool bit from the rotating means

2. The method for coloring a recognizable tool bit as claimed in claim 2, wherein the setting step is provided for setting a contacting time whereof the daubing means contacted with the tool bit for adjusting the thickness of the colored layer of the tool bit.

3. The method for coloring a recognizable tool bit as claimed in claim 2, wherein the setting step is provided for setting a rotating time whereof the rotating means rotating the tool bit for adjusting the thickness of the colored layer of the tool bit.

4. An apparatus for coloring a recognizable tool bit comprising:
an operating system including:
a rotating mechanism, the rotating mechanism having a rotor extending therefrom for adapting to connect to a tool bit; and
a moving mechanism being movable relative to the rotating mechanism and selectively contacted with the rotating mechanism, the moving mechanism including:
a supplying mechanism provided for adapting to store dyestuffs and inject the dyestuffs for coloring the tool bit; and
a daubing mechanism relatively connected to the supplying mechanism, the daubing mechanism having a brush mounted thereon, the brush contacted with the supplying mechanism for soaking dyestuffs from the supplying mechanism and daubing the dyestuff on the tool bit;
a control system electrically connected to the operating system, the control system having a switch provided for switching on the operating system;
wherein when the switch of the control system is switched on, the rotor of the rotating mechanism rotating the tool bit, the supplying mechanism and the daubing mechanism moved by the moving mechanism such that the brush contacts with the tool bit for coloring the tool bit to be a recognizable tool bit.

5. The apparatus for coloring a recognizable tool bit as claimed in claim 4, wherein the control system has a display module mounted thereon, the display module including a supplying counter provided for showing an injecting time of the supplying mechanism, a contacting counter provided for showing a contacting time whereof the brush contacted with the tool bit, and a rotating counter provided for showing a rotating time of the rotor.

7. The apparatus for coloring a recognizable tool bit as claimed in claim 4, wherein the switch is a pedal-typed switch.

8. The apparatus for coloring a recognizable tool bit as claimed in claim 4, wherein the control system has a button assembly mounted thereon and provided for adjusting a flow rate of the dyestuffs supplied by the supplying mechanism.

9. The apparatus for coloring a recognizable tool bit as claimed in claim 4, wherein the control system has a button assembly mounted thereon and provided for adjusting a contacting time whereof the brush contacted with the tool bit.

10. The apparatus for coloring a recognizable tool bit as claimed in claim 4, wherein the control system has a button assembly mounted thereon and provided for adjusting a number of cycles of the rotor.

11. The apparatus for coloring a recognizable tool bit as claimed in claim 4, wherein the supplying mechanism is a high pressure supplying mechanism.
